(19) United States
(12) Patent Application Publication
(10) Pub. No.: US 2007/0156405 A1
(43) Pub. Date: Jul. 5, 2007

(54) Speech recognition system

(76) Inventors: Matthias Schulz, Westerstetten (DE); Franz Gerl, Neu-Ulm (DE); Markus Schwarz, Ulm (DE); Andreas Kosmala, Laupheim (DE); Barbel Jeschke, Lonsee (DE)

Correspondence Address: BRINKS HOFER GILSON & LIONE, P.O. BOX 10395, CHICAGO, IL, 60610, US

(21) Appl. No.: 11/603,265

(22) Filed: Nov. 21, 2006

(30) Foreign Application Priority Data
May 23, 2005 (EP) PCT/EP05/05568
May 21, 2004 (EP) 04012134.5

(51) Int. Cl. G10L 15/28

(52) U.S. Cl. 704/255

(57) ABSTRACT

A speech recognition system receives digital data. The system determines whether a memory contains some or all of the digital data. When some or all of the digital data does not exist in the memory, the system generates a transcription of the missing parts and stores the missing portion and a corresponding transcription in the memory.

### 1. PRIORITY CLAIM

This application claims the benefit of priority from International Application No. PCT/EP2005/005568, filed May 23, 2005, which is incorporated by reference.

### 2. TECHNICAL FIELD

The invention relates to a speech recognition system, and more particularly to a system that generates a vocabulary for a speech recognizer.

### 3. RELATED ART

Speech recognition systems may interface users to machines. Some speech recognition systems may be configured to process a received speech input and control a connected device. When speech is received, some of speech recognition systems search through a large number of stored speech patterns to try and match the input. If the speech recognition system has limited processing resources, a user may notice poor system performance. Therefore, a need exists for an improved speech recognition system.

### SUMMARY

A speech recognition system receives digital data. The system determines whether a memory contains some or all of the digital data. When some or all of the digital data does not exist in the memory, the system generates a transcription of the missing parts and stores the missing portion and a corresponding transcription in the memory.

The speech recognition system includes an interface, a processor, and a memory. The interface receives digital data from an external source. The processor determines whether some or all of the received digital data exists in the memory. Digital data missing from the memory is transcribed and the digital data along with the transcription are stored in the memory.

Other systems, methods, features and advantages will be or will become apparent to one with skill in the art upon examination of the following figures and detailed description. It is intended that all such additional systems, methods, features, and advantages be included within this description, be within the scope of the invention, and be protected by the following claims.

### BRIEF DESCRIPTION OF THE DRAWINGS

The system may be better understood with reference to the following drawings and description. The components in the figures are not necessarily to scale, emphasis instead being placed upon illustrating the principles of the invention. Moreover, in the figures, like referenced numerals designate corresponding parts through the different views.

FIG. 1 is a block diagram of a speech recognition system.

FIG. 2 is a flowchart of a speech recognition method.

FIG. 3 is an alternate flowchart of a speech recognition method.

FIG. 4 is a memory that stores received data.

FIG. 5 is a memory that stores fragment related data.

FIG. 6 is an alternate block diagram of a speech recognition system.

### DETAILED DESCRIPTION OF THE PREFERRED EMBODIMENTS

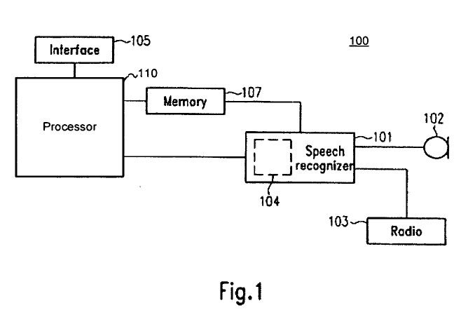

FIG. 1 is a block diagram of a speech recognition system 100. The speech recognition system comprises a speech recognizer 101 that may recognize a speech input. An input device 102 may receive a sound wave or energy representing a voiced or unvoiced input, and may convert this input into electrical or optical energy. The input device 102 may convert the electrical or optical energy into a digital format prior to transmitting the received input to the speech recognizer 101. The input device 102 may be a microphone, and may include an internal or external analog-to-digital converter. Alternatively, the speech recognizer 101 may include an analog-to-digital convert at its input.

In some speech recognition systems 100, the input device 102 may include several microphones coupled together, such as a microphone array. Signals received from the microphone array may be processed by a beamformer which may exploit the lag time from direct and reflected signals arriving from different directions to obtain a combined signal that has a specific directivity. This may be particularly useful if the speech recognition system is used in a noisy environment, such as in a vehicle cabin or other enclosed area.

The speech recognition system in FIG. 1 may control one or more devices in response to speech inputs. The speech recognizer 101 may process a received speech input by hardware and/or software to identify the utterances of the speech input. The identification of the utterances may be based on the presence of pauses between utterances. Alternatively, the identification may be based on the prediction of a beginning and/or ending endpoint of an utterance. The speech recognizer 101 may compare a speech input from a user with speech patterns that have been previously stored in a memory 104. If the speech input is sufficiently identifiable, according to a recognition algorithm, to one of the stored speech patterns, the speech input is recognized as the speech pattern. A recognition algorithm may be based on template matching, Hidden Markov Models and/or artificial neuron networks. The memory 104 may include a volatile or non-volatile memory, and may store a vocabulary that may control a connected device. The connected device could be radio 103, a navigation system, air conditioning system, infotainment system, power windows or door locks, mobile telephone, personal digital assistant (“PDA”), or other device that may be connected to a speech recognition system.

An interface 105 may receive a digital data representing information that may be used by the speech recognizer 101 to control a connected device. The interface may be configured to receive the digital data through a network connection. The network connection may be a wireless protocol. In some speech recognition systems 100, the wireless protocol may be the radio data system (“RDS”) or Radio Broadcast Data System (“RBDS”) which may transmit data relating to radio station's name, abbreviation, program type, and/or song information. Other wireless protocols may include Bluetooth®, WiFi, UltraBand, WiMax, Mobil-Fi, Zigbee, or other mobility connections or combinations.

The digital data received by interface 105 may be used to provide additional vocabulary data to the speech recognizer 101. A processor 110 may be coupled to the interface 105. The processor 110 may determine whether some or all of the received digital data is present in a memory 107. The processor 110 may receive a digital data and may separate the data into data fragments according to categories. These categories may include letters, numbers, and/or special characters. A data fragment may include one character or a sequence of several characters. A character may include letters, numbers (digits), and/or special characters, such as a dash, a blank, or a dot/period.

The memory 107 may be configured as a look up table comprising lists of digital data and corresponding transcriptions of the digital data. The processor 110 may be coupled to the memory 107 and may determine whether some or all of the received data is present in the memory 107 by comparing a data fragment to the list of entries stored in the memory 107.

The processor 110 may also be configured to generate phonetic transcriptions of some or all of the received digital data if it is determined that the digital data is not already stored in the memory 107. The processor 110 may include a text-to-speech module and/or software that are configured to phonetically transcribe received digital data that is not present in the memory 107. The phonetic transcription may include generating data representing a spelled form, a pronounced form, or a combined spelled and pronounced form of a data fragment. A spelled form may generate data where each character of the data fragment is spelled. In pronounced form, a sequence of characters may be pronounced or enunciated as a whole word. In a combined form, part of the data fragment may be spelled and another part may be pronounced. The form of a phonetic transcription may depend on various criteria. These criteria may include the length of a data fragment (number of characters), the type of neighboring fragments, the presence of consonants and/or vowels, and/or the prediction or presence of upper or lower case characters. For exemplary purposes, a data fragment consisting of only consonants may be phonetically transcribed in spelled form.

Each data fragment and corresponding phonetic transcription may be stored in the memory 107 which is also accessible by the speech recognizer 101. Alternatively, the data fragment and corresponding phonetic transcription could be passed to the speech recognizer 101 and stored in memory 104 or stored in a memory internal to the processor 110.

In an alternate speech recognition system 100, memory 107 may be integrated with or coupled to the processor 110. In other speech recognition systems 100, the phonetic transcription may be performed by a device external to the processor 110.

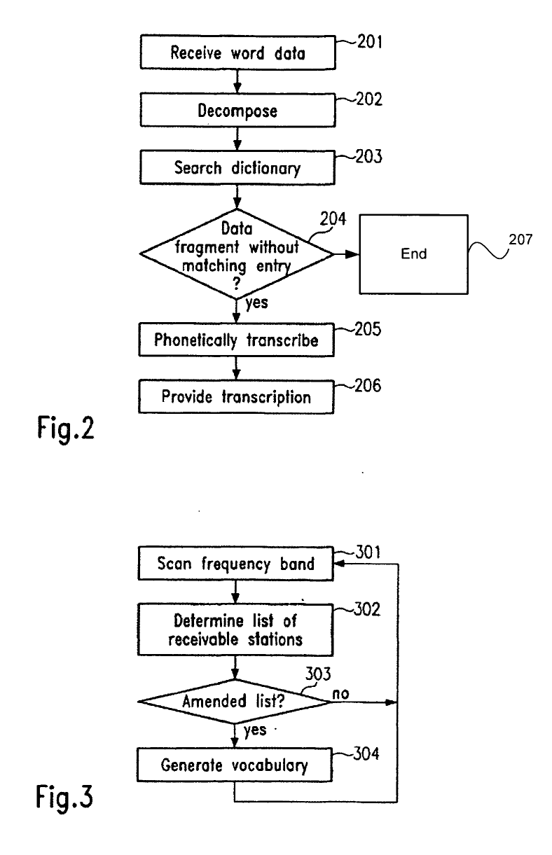

FIG. 2 is a flowchart of a speech recognition method. At Act 201, digital data is received. The digital data may include names and/or call letters of radio stations. The received digital data may comprise “SWR 4 HN” for example. This could stand for the radio station “Südwestrundfunk 4 Heilbronn.” When receiving the name of this radio station, the corresponding frequency on which these radio signals are transmitted may be also known. For instance, the frequency of the signal that contained the received digital data may represent the frequency of the source (e.g., radio station).

At Act 202, the digital data “SWR 4 HN” may be decomposed (e.g., separated) according to predetermined categories. The predetermined categories may include “letters,” “number,” and/or “special characters.” The digital data “SWR 4 HN” may be categorized as “letters” and “numbers.” Analysis of the digital data word “SWR 4 HN” may start with the left most character which is the “S.” This character could be categorized as a “letter.” The subsequent characters “W and “R” would also be categorized as “letters.” After these three letters, there is a blank which may be categorized as a “special character.” The character “4,” may be categorized as a “number.” Therefore, the sequence of characters belonging to the same category, namely, the category “letters” is terminated and a first data fragment “SWR” is determined. The following blank constitutes a next fragment.

The number “4” is followed by a blank and, then, by the character “H”, which is categorized as a “letter.” Therefore, another fragment is determined to consist of the number “4.” This fragment is categorized as “numbers.” Following the “H” is the letter “N.” This is a last fragment consisting of the letters “H” and “N.” As a result, the digital data “SWR 4 HN” could be decomposed into fragments “SWR”, “4”, “HN,” and two special character fragments consisting of blanks.

Other variants of decomposing the digital data may be used. The data may be decomposed in different parts that are separated from another by a blank or a special character such as a dash or a dot. A system may perform the decomposition into letters and numbers as described above. In “SWR 4 HN” example, decomposition into sequences of characters being separated by a blank would already yield the three fragments “SWR”, “4” and “HN” and the two special character fragments. A further decomposition into letter fragments and number fragments would not change this decomposition. Other variants of decomposing the digital data may begin the operation from the right as opposed to the left.

At act 203, a memory (e.g., dictionary) that may retain a reference list may be searched to determine whether there are any entries matching one or a sequence of the decomposed data fragments. Searching the dictionary may include matching each character of a data fragment with the characters of an entry stored in the dictionary. Alternatively, searching the dictionary may include a phonetic comparison of the data fragment with an entry in the dictionary.

The dictionary may include words and/or abbreviations. Where the speech recognition system is used to control a radio, the dictionary may include the names and/or abbreviations of radio stations. For each data fragment or possibly for a sequence of data fragments, the dictionary is searched. The dictionary may also be decomposed into different sub-dictionaries each including entries belonging to a specific category. In this case, one sub-dictionary may include entries consisting of letters and another sub-dictionary may include entries consisting of numbers. Then, only the letter sub-dictionary would be searched with respect to letter data fragments and only the number sub-dictionary would be searched with regard to number data fragments. In this way, the processing time may be considerably reduced.

At act 204, it is determined whether there is any data fragment that does not match an entry in the dictionary. If this is not the case, the process may be terminated at act 207 since the digital word data is already present in the dictionary. Since the dictionary includes the phonetic transcription, the speech recognizer 101 has all the necessary information for recognizing these fragments.

If there are one or more data fragments for which no matching entry has been found in the dictionary, the process proceeds to act 205. At act 205, each data fragment is phonetically transcribed. Phonetic transcription may include generating a speech pattern corresponding to the pronunciation of the data fragment. A text to speech (“TTS”) synthesizer may be used to generate the phonetic transcription. At act 205, it is also decided according to a predetermined criterion what phonetic transcription is to be performed. In some speech recognition systems, a criterion may be that for data fragments consisting of less than a predetermined number of characters, a phonetic transcription in spelled form is always selected. The criterion may also depend (additionally or alternatively) on the appearance of upper and lower case characters, on the type and/or presence of neighboring (preceding or following) fragments, the length of a data fragment (number of characters), and/or the presence of consonants and/or vowels

Other phonetic transcription criteria may include spelling letter data fragments that consist of all consonants. In other words, the resulting phonetic pattern corresponds to spelling the letters of the data fragment. This is particularly useful for abbreviations not containing any vowels which would also be spelled by a user. However, in other cases, it might be useful to perform a composed phonetic transcription consisting of phonetic transcriptions in spelled and in pronounced form.

At act 206, the phonetic transcriptions and the corresponding digital data fragments may be provided to the speech recognizer 101. The phonetic transcriptions and corresponding digital data fragments may be stored in the memory of the speech recognizer and/or stored in an external memory accessible by the speech recognizer. Thus, the vocabulary for speech recognition is extended.

FIG. 3 is an alternate flow chart of a speech recognition method. The method of FIG. 3 may be used in conjunction with a scanable radio or other communication devices. At act 301, a radio frequency band is scanned. This may be performed upon a corresponding request by a speech recognizer or may be performed manually or automatically. During the scanning of the frequency band, it may be possible to determine the frequencies for all of the signals that are receivable by the radio.

At act 302, a list of receivable stations may be determined. When scanning a frequency band, each time a frequency is encountered at which a radio signal is received, this frequency may be stored with other specific information. The information may include the name and/or abbreviation of the received radio station, programming type, signal frequency, or other information.

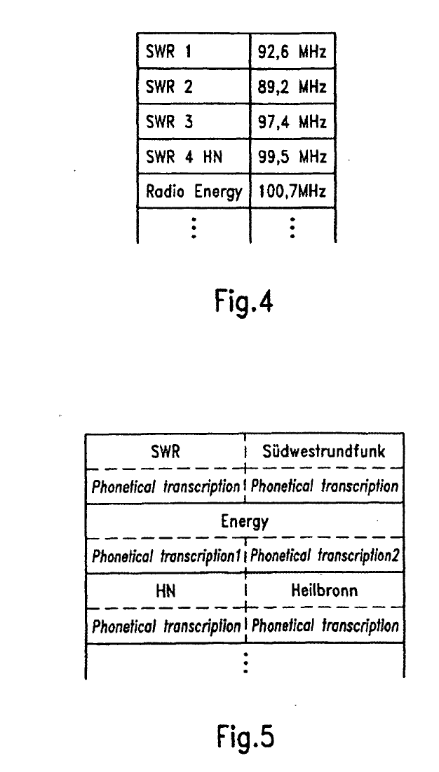

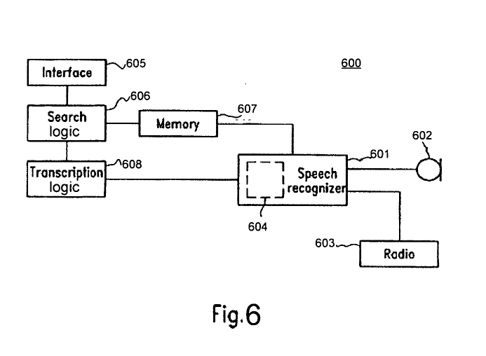

FIG. 4 is an exemplary list of received radio station information that may be retained in a memory. The left column is the name of the radio station as received through RDS or RBDS and the right column lists the corresponding frequencies at which these radio stations may be received. The data of FIG. 4 could be stored in different ways and/or in different memories.

At act 303, it is determined whether there is already a list of receivable radio stations present or whether the current list has changed with respect to a previously stored list of radio stations. The latter may happen in the case of a vehicle radio when the driver is moving between different transmitter coverage areas. In this situation, some radio stations may become receivable at a certain time whereas other radio stations may no longer be receivable. Act 303 may determine if a list of receivable radio stations has changed by comparing a previously stored list to a recently received list. If the list of receivable radio stations has changed, the system may overwrite the previously stored list, or may remove the old stations that are no longer present and add the new stations. At act 304 vocabulary corresponding to the list of updated radio stations may be generated. This may be performed according to the method illustrated in FIG. 2. The methods of FIGS. 2 and 3 may be performed continuously or after regularly predetermined time intervals.

FIG. 5 illustrates a memory that may retain a reference list that may be searched in act 203 of the method shown in FIG. 2. For each entry there may be a corresponding phonetic transcription. As shown in FIG. 5, one entry may read “SWR”. This entry is an abbreviation. For this entry, the memory may retain the corresponding full word “Südwestrundfunk” together with its phonetic transcription. If there is a radio station called “Radio Energy”, the memory could also include the entry “Energy”. For this entry, two different phonetic transcriptions are present, the first phonetic transcription corresponding to an English pronunciation and a second phonetic transcription corresponding to a German pronunciation of the word “energy.” Thus, a speech recognizer could recognize the term “energy” even if a speaker uses a German pronunciation.

In the case of radio stations that are identified by their frequency, the dictionary may also comprise entries corresponding to different ways to pronounce or spell this frequency. For exemplary purposes, if a radio station is received at 94.3 MHz, the dictionary could include entries corresponding to “ninety-four dot three,” “ninety-four three,” “nine four three,” and/or “nine four period three.” Therefore, a user may pronounce the “dot” or not. In both cases, a speech recognizer could recognizer the frequency.

In the foregoing, the method for generating a vocabulary for a speech recognizer was described in the context of a radio, in particular, a vehicle radio. The method may be used in other fields as well including a speech recognizer for mobile phones. In such a case, a vocabulary may be generated based on an address book stored on the SIM card of the mobile phone or in a mobile phone's memory. In such a case, this address book database may be uploaded, when switching on the mobile phone and the method according to FIG. 2 may be performed. In other words, the steps of this method are performed for the different entries of the address book. Additionally, a memory (e.g., dictionary) may be provided already including some names and their pronunciations. Furthermore, the dictionary may also include synonyms, abbreviations and/or different pronunciations for some or all of the entries. In this case, an entry “Dad” in the dictionary could also be associated with “Father” and “Daddy”.

The method shown in FIG. 2, in addition to the other methods described above, may be encoded in a signal bearing medium, a computer readable medium such as a memory, programmed within a device such as one or more integrated circuits, or processed by a controller or a computer. If the methods are performed by software, the software may reside in a memory resident to or interfaced to the processor 110, the interface 105, the speech recognizer 101, or any type of communication interface. The memory may include an ordered listing of executable instructions for implementing logical functions. A logical function may be implemented through digital circuitry, through source code, through analog circuitry, or through an analog source such as through an electrical, audio, or video signal. The software may be embodied in any computer-readable or signal-bearing medium, for use by, or in connection with an instruction executable system, apparatus, or device. Such a system may include a computer-based system, a processor-containing system, or another system that may selectively fetch instructions from an instruction executable system, apparatus, or device that may also execute instructions.

A “computer-readable medium,” “machine-readable medium,” “propagated-signal” medium, and/or “signal-bearing medium” may comprise any means that contains, stores, communicates, propagates, or transports software for use by or in connection with an instruction executable system, apparatus, or device. The machine-readable medium may selectively be, but not limited to, an electronic, magnetic, optical, electromagnetic, infrared, or semiconductor system, apparatus, device, or propagation medium. A non-exhaustive list of examples of a machine-readable medium would include: an electrical connection “electronic” having one or more wires, a portable magnetic or optical disk, a volatile memory such as a Random Access Memory “RAM” (electronic), a Read-Only Memory “ROM” (electronic), an Erasable Programmable Read-Only Memory (EPROM or Flash memory) (electronic), or an optical fiber (optical). A machine-readable medium may also include a tangible medium upon which software is printed, as the software may be electronically stored as an image or in another format (e.g., through an optical scan), then compiled, and/or interpreted or otherwise processed. The processed medium may then be stored in a computer and/or machine memory.

While various embodiments of the invention have been described, it will be apparent to those of ordinary skill in the art that many more embodiments and implementations are possible within the scope of the invention. Accordingly, the invention is not to be restricted except in light of the attached claims and their equivalents.

1. A method of generating a speech recognizer vocabulary, comprising:
receiving digital data;
searching the digital data automatically in a predetermined dictionary; and
transcribing the digital data phonetically when the dictionary does not contain a matching entry,
where the dictionary comprises a phonetic transcription for each entry.

2. The method of claim 1, where the act of searching the digital data comprises decomposing the digital data into a data fragment according to one or more predetermined categories and performing a comparison with data stored in the dictionary.

3. The method of claim 2, where the act of decomposing the digital data into a data fragment comprises separating the digital data into a component comprising letters.

4. The method of claim 2, where the act of decomposing the digital data into a data fragment comprises separating the digital data into a component comprising numbers.

5. The method of claim 2, where the act of decomposing the digital data into a data fragment comprises separating the digital data into a component comprising special characters.

6. The method of claim 1, where the act of transcribing the digital data phonetically comprises determining according to a predetermined criterion whether to phonetically transcribe a part of the received digital data in spelled form, in pronounced form, or in a combination of spelled and pronounced form.

7. The method of claim 1, where the act of transcribing the digital data phonetically comprises storing in a memory the data fragment in spelled form when the data fragment consists of only consonants.

8. The method of claim 1, where the act of receiving digital data comprises receiving digital data through a wireless protocol.

9. The method of claim 1, where the act of receiving digital data is in response to a request for digital data.

10. The method of claim 1, where the digital data comprises a name.

11. The method of claim 1, where the dictionary further comprises a synonym for at least one dictionary entry.

12. A signal-bearing medium having software that generates a speech recognizer vocabulary in response to receiving digital data, comprising:
to searching for the digital data in an electronic dictionary; and
transcribing the digital data phonetically when the dictionary does not contain a matching entry.

13. A speech recognition system, comprising:
a speech recognizer that recognizes speech input;
an interface configured to receive digital data;
a memory configured to store one or more digital data entries and a corresponding phonetic data
means for searching the memory to determine if a received digital data exists in the memory;
means for transcribing the received digital data phonetically when the received digital data is not present in the memory.

14. The speech recognition system of claim 13, where the means for searching is configured to decompose the digital data into data fragments according to predetermined categories and to search the memory for a corresponding entry.

15. The speech recognition system of claim 14, where the means for searching is configured to decompose the digital data into data fragments consisting of letters.

16. The speech recognition system of claim 14, where the means for searching is configured to decompose the digital data into fragments consisting of numbers.

17. The speech recognition system of claim 14, where the means for searching is configured to decompose the digital data into fragments consisting of special characters.

18. The speech recognition system of claim 13, where the means for transcribing the received digital data phonetically is configured to determine according to a predetermined criterion whether to transcribe a part of the received digital data in spelled form, in pronounced form, or a combination of spelled and pronounced form.

19. The speech recognition system of claim 18, where the means for transcribing the received digital data phonetically is configured to transcribe in spelled form each letter of a part of the received digital data solely consisting of consonants.

20. The speech recognition system of claim 13, where the interface is configured to automatically request digital data.

21. The speech recognition system of claim 13, where the interface is configure to upload digital data from a name database.

22. The speech recognition system of claim 13, where the dictionary further comprises an abbreviation for at least one memory entry.
